(19) United States
(12) Patent Application Publication
(10) Pub. No.: US 2024/0242082 A1
(43) Pub. Date: Jul. 18, 2024

(54) METHOD AND APPARATUS WITH TEACHERLESS STUDENT MODEL FOR CLASSIFICATION

(71) Applicant: SAMSUNG ELECTRONICS CO., LTD., Suwon-si (KR)

(72) Inventors: Seohyung LEE, Suwon-si (KR); Jiho CHOI, Suwon-si (KR); Byung In YOO, Suwon-si (KR)

(73) Assignee: SAMSUNG ELECTRONICS CO., LTD., Suwon-si (KR)

(21) Appl. No.: 18/338,732

(22) Filed: Jun. 21, 2023

(30) Foreign Application Priority Data
Jan. 18, 2023 (KR) 10-2023-0007658

(51) Int. Cl. G06N 3/09; G06N 3/048

(52) U.S. Cl. CPC G06N 3/09; G06N 3/048

(57) ABSTRACT

An apparatus and method for training a neural network model for classification without a teacher model are disclosed. The includes: selecting classes from a database comprising a set of classes; generating a mean feature group comprising mean features extracted from the selected classes; receiving a batch comprising input data and extracting, by the neural network model, a feature from the input data, wherein the neural network model is to be trained according to a mean feature set; determining a first similarity between the extracted feature and a mean feature corresponding to the input data; determining a second similarity comprising a self-similarity of the mean feature; and updating a parameter of the neural network model based on the first similarity and the second similarity.

### CROSS-REFERENCE TO RELATED APPLICATIONS

This application claims the benefit under 35 USC § 119(a) of Korean Patent Application No. 10-2023-0007658, filed on Jan. 18, 2023, in the Korean Intellectual Property Office, the entire disclosure of which is incorporated herein by reference for all purposes.

### BACKGROUND

### 1. Field

The following description relates to an apparatus and method for training a student neural network model for classification without requiring a teacher model.

### 2. Description of Related Art

Recently, research on neural networks (NNs) that are capable of learning to solve arbitrary problems for arbitrary inputs have been used in various ways.

NNs are widely used in the image processing field, for example, and research on various NN training methods is being conducted to acquire an accurate image processing result based on an input image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of training a neural network model includes: selecting classes from a database comprising a set of classes; generating a mean feature group comprising mean features extracted from the selected classes; receiving a batch comprising input data and extracting, by the neural network model, a feature from the input data, wherein the neural network model is to be trained according to a mean feature set; determining a first similarity between the extracted feature and a mean feature corresponding to the input data; determining a second similarity comprising a self-similarity of the mean feature; and updating a parameter of the neural network model based on the first similarity and the second similarity.

The selecting of the classes may include: selecting a first number of classes in ascending order of a variance feature from among classes in the database; and selecting the classes by selecting a second number of classes having a farthest distance between mean features from among the first number of classes.

The first similarity may be determined based on a cosine similarity of a matrix for the extracted feature and a transposed matrix of a matrix for the mean feature.

The determining of the second similarity may be based on a cosine similarity of a matrix for the mean feature and a transposed matrix of a matrix for the mean feature.

The parameter of the student model may be updated based on a cosine similarity of a matrix for the first similarity and a matrix for the second similarity.

The parameter of the student model may be updated such that a loss function based on a matrix for the first similarity and a matrix for the second similarity is minimized.

The mean feature may be determined based on the number of classes and a channel size of the mean feature set.

The extracted feature may be determined based on a batch size of batches comprising the input data and a channel size of the mean feature set.

A non-transitory computer-readable storage medium may store instructions that, when executed by a processor, cause the processor to perform any of the methods.

In another general aspect, an apparatus for training a neural network model includes: one or more processors; and a memory storing that when executed by the one or more processors cause the one or more processors to: select classes to be used for training from a database of classes; generate a mean feature group comprising the mean features by extracting the mean features from the selected classes; receive a batch comprising input data and extract a feature from the input data by the neural network model, wherein the neural network model is to be trained based on a mean feature set; determine a first similarity between the extracted feature and a mean feature corresponding to the input data among the mean features; determine a second similarity comprising a self-similarity of the mean feature; and update a parameter of the student model based on the first similarity and the second similarity.

The instructions may be further configured to cause the one or more processors to: select a first number of classes predetermined in ascending order of a variance feature from among classes in the database; and select the classes by selecting a second number of classes having a farthest distance between mean features from among the first number of classes.

The instructions may be further configured to cause the one or more processors to determine the first similarity based on a cosine similarity of a matrix for the extracted feature and a transposed matrix of a matrix for the mean feature.

The instructions are further configured to cause the one or more processors to determine the second similarity based on a cosine similarity of a matrix for the mean feature and a transposed matrix of a matrix for the mean feature.

The instructions may be further configured to cause the one or more processors to update the parameter of the student model based on a cosine similarity of a matrix for the first similarity and a matrix for the second similarity.

The instructions may be further configured to cause the one or more processors to update the parameter of the student model so that a loss function based on a matrix for the first similarity and a matrix for the second similarity is minimized.

Other features and aspects will be apparent from the following detailed description, the drawings, and the claims.

### BRIEF DESCRIPTION OF THE DRAWINGS

FIG. 1 illustrates an example of a neural network model, according to one or more embodiments.

FIG. 2 illustrates an example of a teacher model and a student model, according to one or more embodiments.

FIG. 3 illustrates an example of a knowledge distillation method according to the related art.

FIGS. 4A and 4B illustrate examples of a mean feature bank of a neural model training apparatus for training a neural network model to classify images without a teacher model, according to one or more embodiments.

FIG. 5 illustrates an example neural network model training apparatus for training a neural network model to classify images without a teacher model, according to one or more embodiments.

FIG. 6 illustrates an example configuration of a neural network model training apparatus for classifying images without a teacher model, according to one or more embodiments.

FIG. 7 illustrates an example method of controlling a neural network model training apparatus for training a neural network model to classify images without a teacher model, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

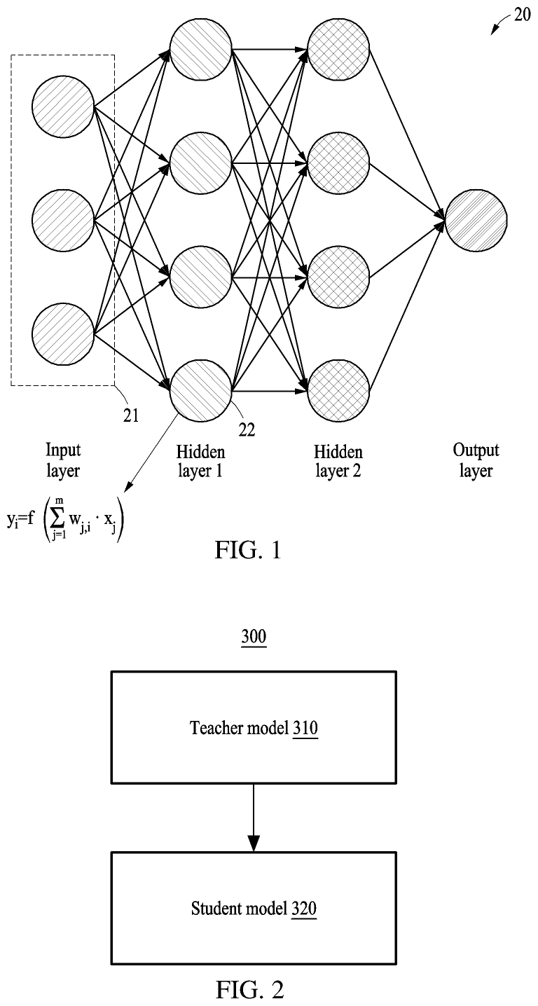

FIG. 1 illustrates an example of a neural network model, according to one or more example embodiments.

Referring to FIG. 1, neural network model 20 is an example of a neural network (NN) that may correspond to a deep neural network (DNN). Although the neural network model 20 is described with reference to the drawing as including two hidden layers, the neural model 20 may include various other numbers of hidden layers. In addition, although the neural model 20 is described with reference to FIG. 1 as including a separate input layer 21 for receiving input data, in some implementations input data may be directly input to a hidden layer.

In the neural network model 20, nodes of each layer (except for the output layer) may be connected to nodes of a next layer via links (connections) to transmit an output signal to the next layer. For one node in a layer, values obtained by multiplying node values output by nodes in a previous layer and weights assigned to respective links to the one node may be input to the one node through such links. The weight may be referred to as a parameter of the neural network model 20. An activation function may be, for example, a sigmoid function, a hyperbolic tangent (tanh) function, a rectified linear unit (ReLU), or the like, and nonlinearity of the neural network model 20 may be formed by the activation function.

An output of an i-th node 22 in the neural model 20 may be expressed by Equation 1.

$${y}_{i} = f ( {\sum }_{j = 1}^{m} {w}_{j , i} {x}_{j} ) \qquad Equation 1$$

Equation 1 denotes an output value yᵢ of the itch node 22 for m input values in an arbitrary layer. xⱼ denotes an output value of a j-th node of a previous layer and w_{j,i} denotes a weight applied to a connector of the j-th node of the previous layer and the i-th node 22 of a current layer. f ( ) denotes an activation function. As shown in Equation 1, for the activation function, a cumulative multiplication result of the input value xⱼ and the weight w_{j,i} may be used. That is, an operation (a multiplication and accumulation (MAC) operation) of multiplying and adding the input value xⱼ and the weight w_{j,i} may be repeated. In addition to these uses, there are various application fields requiring a MAC operation, and for this purpose, a processing device that may process the MAC operation in an analog circuit area may be used, although other devices may be used, for example ordinary processors, graphics processing units, etc.

A node in the neural network model 20 may include a weight or a combination of bias. The neural network model 20 may include the node or a layer including a node. The neural model 20 may infer (or predict) a result from an arbitrary input according to weights of nodes that can be changed through training.

The neural network model 20 may be or may include a DNN. For example, the neural network model 20 may be, or may include, a convolutional neural network (CNN), a recurrent neural network (RNN), a perceptron, a multilayer perceptron, a feed forward (FF) network, a radial basis network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural Turing machine (NTM), a capsule network (CN), a Kohonen network (KN), an attention network (AN), etc., or combinations thereof. The neural network model 20 is not limited to these examples.

FIG. 2 illustrates an example of a teacher model and a student model, according to one or more embodiments.

FIG. 2 shows a teacher model 310 and a student model 320. The teacher model 310 and the student model 320 may each include, for example, a neural network as a model trained to output a predetermined output for a predetermined input. The neural network may be a recognition model with a large number of nodes interconnected by connections or links. The nodes may be interconnected to each other via the connections having respective connection weights. A connection weight, which is a parameter of the neural network, is a value of a connection and may also be referred to as a connection strength. The neural network may perform a learning process through the nodes and weights. A model training apparatus may update the connection weights between nodes through a delta rule and backpropagation learning, for example. Backpropagation learning is a method of estimating loss by performing forward computation on given input data, propagating the estimated loss in a reverse direction from the output layer through the hidden layers to the input layer, and updating the connection weights to reduce the loss. The neural network processing (inferencing) may proceed in the order of the input layer, the hidden layers, and the output layer. However, updating the connection weights in backpropagation learning may proceed in the opposite order, i.e., in the order of the output layer, the hidden layers, and the input layer. Hereinafter, training the neural network may be understood to refer to training parameters of the neural network (e.g., weights). In addition, the trained neural network may be understood as being a neural network having trained parameters. The teacher model 310 and the student model 320 may both represent neural networks of different sizes with the same target to be recognized. The teacher-student configuration is an example of a knowledge-transfer neural network. As described herein, knowledge may be transferred to a student model without requiring the use of a teacher model.

The teacher model 310 may be a model that recognizes target data at high accuracy using sufficiently numerous features extracted from the target data to be recognized and may be a neural network having a larger size than that of the student model 320. The teacher model 310 may include more hidden layers, more nodes, or a combination thereof, as compared to the student model 320. The student model 320 may be a neural network having a smaller size than that of the teacher model 310 and may have a faster recognition rate than that of the teacher model 310 due to the smaller size thereof. The student model 320 may be trained based on information from the teacher model 310 so that output data of the teacher model 310 is output from input data. The output data of the teacher model 310 may be a value of logit and a value of probability output from the teacher model 310, or a classification output value derived from hidden layers of the teacher model 310. Through this, the student model 320 may be acquired and may have a faster recognition rate than that of the teacher model 310 while generally outputting the same value as the teacher model 310. This process may be referred to as model compression or knowledge transfer. Model compression is a technique that may be used for training the student model 320 using output data of the teacher model 310 instead of (or in addition) training with ground truth data that has true labels of input data items. The teacher model 310 used when training the student model 320 may be provided in plurality (i.e., more than one teacher model may be used). The student model 320 may be trained by selecting at least one of the teacher models 310 to aid in training the student model 320. A process of training the student model 320 by selecting at least one of multiple teacher models 310 may be repeatedly performed until the student model 320 satisfies a predetermined condition. Here, the selected teacher model for training the student model 320 may be newly selected each time the training process is repeated. One or more teacher models 310 may be selected as a model for training the student model 320. As described above, this concept for transmitting knowledge of a large model to a small model by transmitting knowledge as if a teacher teaches a student is sometimes also referred to as knowledge distillation.

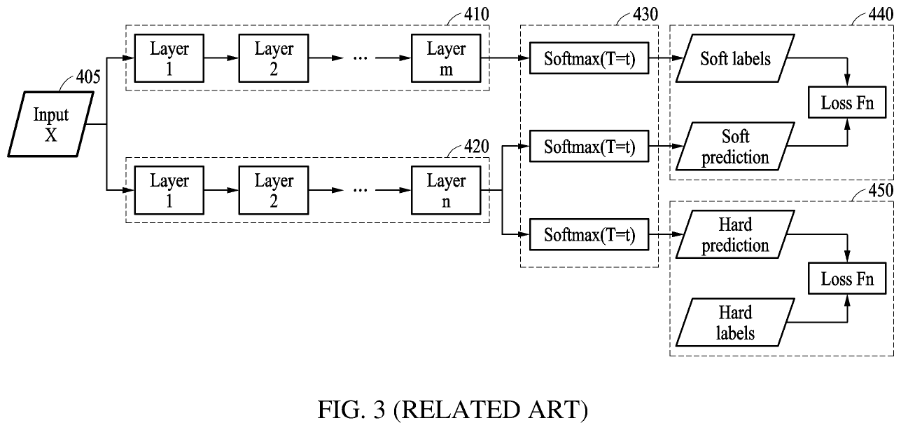

FIG. 3 illustrates an example of a knowledge distillation method according to the related art.

Referring to FIG. 3, additional details of the knowledge distillation method described with reference to FIG. 2 may be found elsewhere. Nonetheless, as shown in FIG. 3, a representative knowledge distillation method may include training a plurality of layers in a teacher model 410 and a plurality of layers in a student model 420 based on input data 405. The knowledge distillation method may include training the student model 420 so that each training loss value is minimized, after operation 430 of converting a probability distribution output from each of the teacher model 410 and the student model 420 into SoftMax, through operation 440 of obtaining cross entropy loss for a difference of a classification result between the teacher model 410 and the student model 420 and operation 450 of obtaining cross entropy loss for a difference of a classification result between the student model 420 and ground truth data.

A recent deep learning trend has been to train a large model such as the teacher model 410 and use the large model for various purposes. However, training a large model such as the teacher model 410 may use a large amount of computing resources and resources such as graphics processing units (GPUs) may be needed. Since most teacher models may use a large portion of limited resources, it can be difficult to train a large model. Conversely, the accuracy of an independently trained small network model is often not high compared to that of a large model. Therefore, knowledge distillation (or knowledge transfer) may be used as one of the methods of training a small network with the help of a well-trained large model.

When knowledge distillation is used well, it may have an advantage in that the work of a smaller model may proceed fast while providing accuracy approximate to that of a large model.

Knowledge distillation methods according to the related art may be mainly classified into three methods, namely, response-based distillation, feature-based distillation, and relation-based distillation.

Response-based distillation may focus on the final result of the teacher model 410, and the student model 420 may simulate the result of the teacher model. In this process, distillation loss may be used. As a result, a difference in the probability distribution of an output between the two models may be reduced and prediction results may also be similar to each other.

Feature-based distillation may use mean features of a model and may utilize mean features that may distinguish detailed features of the model to the teacher model 410. With feature-based distillation, the student model 420 may be trained in a way that reduces a difference of feature activations between the teacher model 410 and the student model 420.

Regarding relationship-based distillation, whereas the previous two methods involve simulating a certain layer of the teacher model 410, relationship-based distillation may involve strengthening a relationship between layers of different models, for example, using singular value decomposition to transmit knowledge.

Knowledge distillation methods may be mainly classified into three classes methods (discussed next) according to the type of knowledge. Which of the three types of methods a method is classified into may depend on whether the teacher model 410 is trained simultaneously with the student model 420.

Offline distillation is a commonly used type of method and may train only the student model 420 without additionally training the teacher model 410 using an already well-trained model as it is.

Online distillation is another type of method in which both the teacher model 410 and the student model 420 are trained simultaneously. Although offline distillation is relatively effective, online distillation may be used when there are limitations.

Self-distillation is a type method in which an initial training result is transmitted to a later training result, with the teacher model 410 being the same as the student model 420.

With prior knowledge distillation methods, to improve the performance of the student model 420, the teacher model 410 must generally be trained with the same data and there is a limitation that the teacher model 410 must perform better than the student model 420. Training of the teacher model 410 generally requires more memory and computation than training of the student model 420, and the training speed of the teacher model 410 is slower than that of training from scratch. When training data is insufficient, it is difficult to accurately train the teacher model 410 to achieve good performance, which makes it difficult to expect improved performance of the student model 420 when knowledge distillation or transfer is applied to the student model 420.

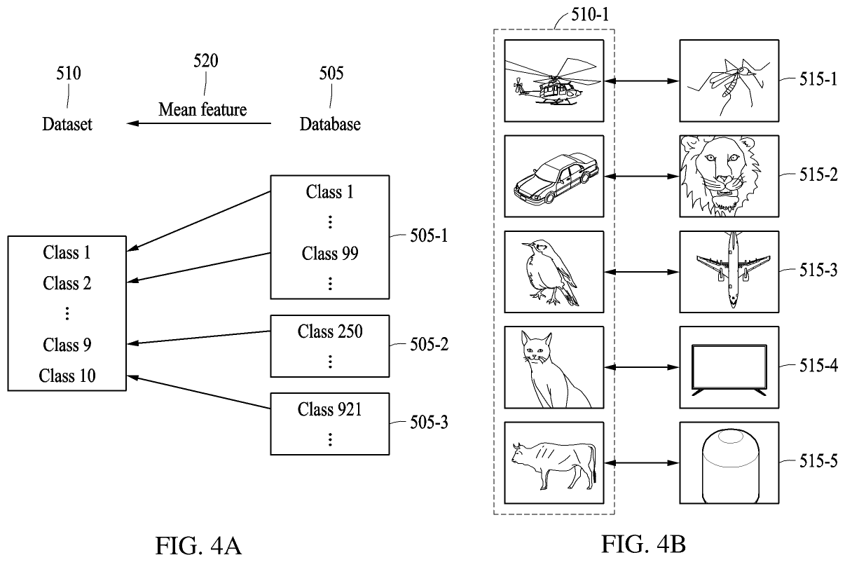

FIGS. 4A and 4B illustrate examples of a mean feature bank of a neural model training apparatus for training a neural network model to classify images without a teacher model, according to one or more embodiments.

Referring to FIG. 4A, knowledge distribution may be accomplished without a teacher model by using a large-scale dataset for training. The large-scale dataset bay be used to generate a mean feature bank for knowledge distillation based training.

FIG. 4A shows an operation in which a neural model training apparatus selects classes 505-1, 505-2, and 505-3 to be used for training from a database 505 including many classes and matches the classes 505-1, 505-2, and 505-3 with classes 510-1 of a dataset 510. The classes in the database 505 may be labeled images (images with class labels), for example. The database 505 may be a large-scale dataset (e.g., an ImageNet) having a sufficiently large amount of data, and values of variance features of each of the classes 505-1, 505-2, and 505-3 (which contain variance features, e.g., variance features of Class 1 and Class 99); each of classes 505-1, 505.2, and 505-3 represent a respective set of classes. in the database 505 may be less than or equal to a predetermined value.

The selecting of the classes 505-1, 505-2, and 505-3 may include selecting a first number of classes predetermined in ascending order of a variance feature from among the classes 505-1, 505-2, and 505-3 in the database 505 and selecting the plurality of classes 505-1, 505-2, and 505-3 by selecting a second number of classes having the furthest distance between mean features 520 from among the first number of classes. As shown in FIG. 4B, a plurality of classes 515-1 to 515-5 may be classes having the farthest distance between mean features 520. A neural model training apparatus may select the classes 515-1 to 515-5 having the farthest distance between the mean features 520 correspond to a class 510-1 of the dataset 510. The selecting of the classes 515-1 to 515-5, however, is not limited to the method described above. For example, the mean features 520 for the classes 515-1 to 515-5 may be obtained by inputting the dataset 510 to a model trained with the database 505 and selecting a class closest to the mean feature 520 (according to an output of the model) for each of the classes 515-1 to 515-5 of the database 505. The selecting of the classes 515-1 to 515-5 may also include selecting a class of the database 505 that is most similar any class of the dataset 510. In addition, although FIGS. 4A and 4B and the description thereof are expressed as classes for specific types of images, this is for description of a specific example; implementations are not limited to the types of images shown in the drawings (or even to image classification) or specific cases directly mentioned in the description of present disclosure.

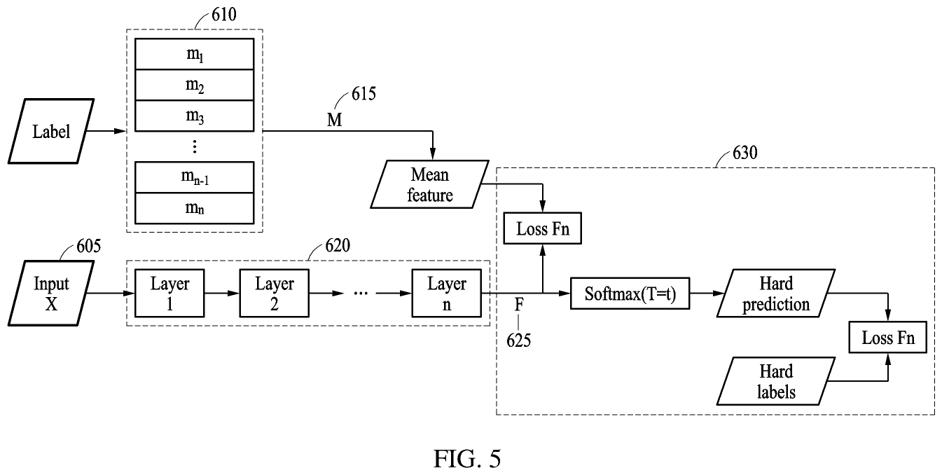

FIG. 5 illustrates an example of a neural model training apparatus that for training a neural network model to classify images without a teacher model, according to one or more embodiments.

Referring to FIG. 5, a neural model training apparatus may perform a knowledge distillation method that improves the performance of a student model that trains a small dataset using a large-scale dataset without a teacher model.

When a student model 620 receives batches including input training data 605 (X), a mean feature bank 610 (generated as discussed with reference to FIGS. 4A and 4B) may output, according to a label associated with the input training data 605 (X) a mean feature 615 corresponding to the input data 605 from among mean features in the mean feature bank 610. The neural model training apparatus may determine a first similarity between the mean feature 615 and a feature 625 extracted from the student model 620. The neural model training apparatus may determine a second similarity between mean features.

The determining of the first similarity between the mean feature 615 and the extracted feature 625 may be based on a cosine similarity of (i) a matrix for the extracted feature 625 and (ii) a transposed matrix of a matrix for the mean feature 615. A cosine similarity between arbitrary matrices arbitrary A and B may be computed according to Equation 2.

$$cosine similarity = {S}_{C} ( A , B ) := cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} \qquad Equation 2$$

The determining of the second similarity between the mean features may be based on a cosine similarity of (i) a matrix M for the mean feature 615 and (ii) a transposed matrix MT of the matrix M for the mean feature 615 (not shown in FIG. 5).

A parameter of the student model 620 may be updated based on the first similarity and the second similarity. The parameter of the student model 620 may be updated based on a cosine similarity of a matrix for the first similarity and a matrix for the second similarity. The updating of the parameter of the student model 620 may include updating the parameter so that a loss function based on a matrix FM^{T} for the first similarity and a matrix MM^{T} for the second similarity is minimized. The updating of the parameter of the student model 620 may include obtaining Kullback-Leibler divergence (KLD) loss and updating the parameter of the student model 620 so that corresponding loss decreases. The updating of the parameter of the student model 620 may include minimizing a value of the loss function defined as in Equation 3.

$${L}_{kd} = - log ( CosineSimilarity ( {FM}^{T} , {MM}^{T} ) ) , \qquad Equation 3$$

where

M∈ [symbol] ^{N×C}, F∈ [symbol] ^{B×C}, and where

$$L = α {L}_{kd} + ( 1 - α ) {L}_{ce}$$

Here, L_{kd} denotes knowledge distillation loss and L_{ce} denotes cross entropy loss. Here, α denotes a balancing parameter. F denotes a matrix for the extracted feature 625 inferred by the student model 620 from the input data 605 (X). M denotes a matrix for the mean feature 615. N denotes the number of classes in the mean feature bank 610. B denotes a batch size of input data received by the student model 620. C denotes a channel size of the mean feature bank 610.

The mean feature 615 and the matrix for the mean feature 615 may be determined based on the number of classes and the channel size of the mean feature bank. The extracted feature 625 and the matrix for the extracted feature 625 may be determined based on the batch size of the batches including input data and the channel size of the mean feature bank 610. The neural model training may update the parameter of the student model 620 based on the first similarity and the second similarity, which may include minimizing the loss function in the general knowledge distillation method as shown in operation 630; e.g. using SoftMax for processing (outputting) the features, and hard predicting the features.

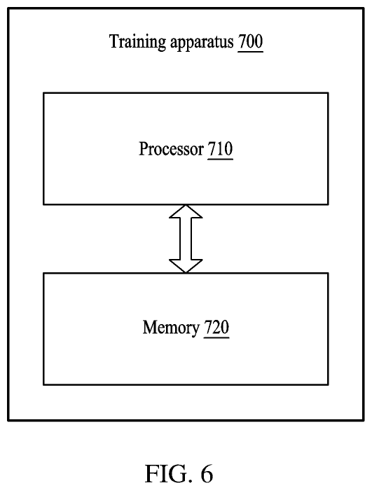

FIG. 6 illustrates an example of a configuration of a neural model training apparatus classifying an image without a teacher model.

Referring to FIG. 6, a training apparatus 700 may include a processor 710 and a memory 720. The description provided with reference to FIGS. 1 to 5 may also apply to FIG. 6.

The memory 720 may store computer-readable instructions. When the computer-readable instructions stored in the memory 720 are executed by the processor 710, the processor 710 may process operations defined by the computer-readable instructions. The memory 720 may include, for example, random-access memory (RAM), dynamic random-access memory (DRAM), static random-access memory (SRAM), or other types of non-volatile memory known in the art. The memory 720 may store a pre-trained ANN model.

The processor 710 may control the overall operation of the training apparatus 700. The processor 710 may be a hardware-implemented apparatus having a circuit that is physically structured to execute desired operations. The desired operations may include code or instructions in a program. The hardware-implemented apparatus may include a microprocessor, a central processing unit (CPU), a GPU, a processor core, a multi-core processor, a multiprocessor, an application-specific integrated circuit (ASIC), a field programmable gate array (FPGA), a neural processing unit (NPU), or the like, or combinations thereof.

The processor 710 may control the training apparatus 700 by executing instructions and functions to be executed by the training apparatus 700.

The training apparatus 700 controlled by the processor 710 may perform selecting of classes to be used for training from a database including a plurality of classes, by extracting mean features from the selected classes, generating a mean feature group including the mean features, receiving a plurality of batches including input data and extracting a feature from a student model to be trained by a mean feature bank, determining a first similarity between a mean feature corresponding to the input data among the mean features and the extracted feature, determining a second similarity between the mean features, and updating a parameter of the student model based on the first similarity and the second similarity.

The training apparatus 700 controlled by the processor 710 may perform selecting a first number of classes predetermined in ascending order of a variance feature from among a plurality of classes in the database and selecting the plurality of classes by selecting a second number of classes having the farthest distance between mean features from among the first number of classes. The database may be a large-scale data set having a sufficiently large amount of data as described with reference to FIGS. 5A and 5B, and variance features of each class in the database may have a very small value that is less than or equal to a predetermined value.

The training apparatus 700 controlled by the processor 710 may perform determining the first similarity based on a cosine similarity of a matrix for an extracted feature and a transposed matrix of a matrix for a mean feature. The cosine similarity may be defined by Equation 2 as described with reference to FIG. 5.

The training apparatus 700 controlled by the processor 710 may perform determining the second similarity based on a cosine similarity of a matrix for a mean feature and a transposed matrix of a matrix for the mean feature. The cosine similarity may be defined by Equation 2 as described with reference to FIG. 5.

The training apparatus 700 controlled by the processor 710 may perform updating a parameter of a student model based on a cosine similarity of a matrix for the first similarity and a matrix for the second similarity. The updating of the parameter of the student model may include obtaining KLD loss and updating the parameter of the student model so that corresponding loss decreases.

The training apparatus 700 controlled by the processor 710 may perform updating the parameter of the student model so that a loss function based on the matrix for the first similarity and the matrix for the second similarity is minimized. The updating of the parameter of the student model may include minimizing a value of the loss function defined as in Equation 3 described with reference to FIG. 5.

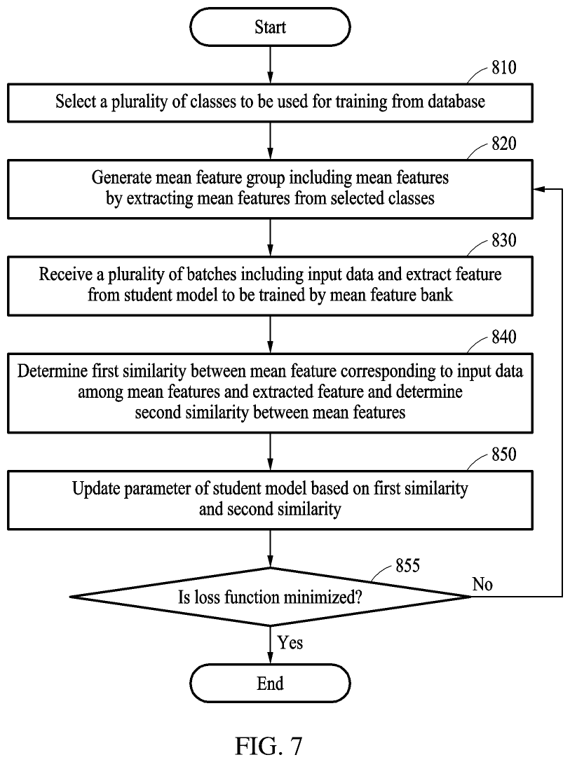

FIG. 7 illustrates an example method of controlling a neural model training apparatus for training a neural network model to classify images without a teacher model, according to one or more embodiments.

Referring to FIG. 7, in operation 810, a neural model training apparatus may select a plurality of classes to be used for training from a database. The selecting of the plurality of classes may correspond to selecting the plurality of classes to be used for training from the database as described with reference to FIG. 4.

In operation 820, the neural model training apparatus may generate a mean feature group including mean features by extracting mean features from the selected classes. The generating of the mean feature group may correspond to generating the mean feature group described with reference to FIGS. 5A and 4B and FIG. 5.

In operation 830, the neural model training apparatus may receive batches including input data and may extract (from the input data) a feature by a student model to be trained by a mean feature bank. The extracting of the feature by the student model may correspond to extracting the feature from the student model as described with reference to FIG. 5.

In operation 840, the neural model training apparatus may determine the first similarity between a mean feature corresponding to input data among mean features and an extracted feature and may determine the second similarity between the mean features. The determining of the first similarity and the second similarity may correspond to determining the first similarity and the second similarity based on the cosine similarity described with reference to FIG. 6.

In operation 850, the neural model training apparatus may update a parameter of the student model based on the first similarity and the second similarity. The updating of the parameter of the student model may correspond to updating the parameter of the student model so that the loss function based on the matrix for the first similarity and the matrix for the second similarity described with reference to FIG. 5 is minimized.

In operation 855, the neural model training apparatus may perform, when it is determined that the loss function is minimized, stopping training and, when the loss function is not minimized, updating the parameter of the student model until the loss function is minimized by repeatedly performing operations 820 to 855 again.

The computing apparatuses, the vehicles, the electronic devices, the processors, the memories, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of training a neural network model, the method comprising:
selecting classes from a database comprising a set of classes;
generating a mean feature group comprising mean features extracted from the selected classes;
receiving a batch comprising input data and extracting, by the neural network model, a feature from the input data, wherein the neural network model is to be trained according to a mean feature set;
determining a first similarity between the extracted feature and a mean feature corresponding to the input data;
determining a second similarity comprising a self-similarity of the mean feature; and
updating a parameter of the neural network model based on the first similarity and the second similarity.

2. The method of claim 1, wherein the selecting of the classes comprises:
selecting a first number of classes in ascending order of a variance feature from among classes in the database; and
selecting the classes by selecting a second number of classes having a farthest distance between mean features from among the first number of classes.

3. The method of claim 1, wherein the first similarity is determined based on a cosine similarity of a matrix for the extracted feature and a transposed matrix of a matrix for the mean feature.

4. The method of claim 1, wherein the determining of the second similarity is based on a cosine similarity of a matrix for the mean feature and a transposed matrix of a matrix for the mean feature.

5. The method of claim 1, wherein the parameter of the student model is updated based on a cosine similarity of a matrix for the first similarity and a matrix for the second similarity.

6. The method of claim 1, wherein the parameter of the student model is updated such that a loss function based on a matrix for the first similarity and a matrix for the second similarity is minimized.

7. The method of claim 1, wherein the mean feature is determined based on the number of classes and a channel size of the mean feature set.

8. The method of claim 1, wherein the extracted feature is determined based on a batch size of batches comprising the input data and a channel size of the mean feature set.

9. A non-transitory computer-readable storage medium storing instructions that, when executed by a processor, cause the processor to perform the method of claim 1.

10. An apparatus for training a neural network model, the apparatus comprising:
one or more processors; and
a memory storing that when executed by the one or more processors cause the one or more processors to:
select classes to be used for training from a database of classes;
generate a mean feature group comprising the mean features by extracting the mean features from the selected classes;
receive a batch comprising input data and extract a feature from the input data by the neural network model, wherein the neural network model is to be trained based on a mean feature set;
determine a first similarity between the extracted feature and a mean feature corresponding to the input data among the mean features;
determine a second similarity comprising a self-similarity of the mean feature; and
update a parameter of the student model based on the first similarity and the second similarity.

11. The apparatus of claim 10, wherein the instructions are further configured to cause the one or more processors to:
select a first number of classes predetermined in ascending order of a variance feature from among classes in the database; and
select the classes by selecting a second number of classes having a farthest distance between mean features from among the first number of classes.

12. The apparatus of claim 10, wherein the instructions are further configured to cause the one or more processors to determine the first similarity based on a cosine similarity of a matrix for the extracted feature and a transposed matrix of a matrix for the mean feature.

13. The apparatus of claim 10, wherein the instructions are further configured to cause the one or more processors to determine the second similarity based on a cosine similarity of a matrix for the mean feature and a transposed matrix of a matrix for the mean feature.

14. The apparatus of claim 10, wherein the instructions are further configured to cause the one or more processors to update the parameter of the student model based on a cosine similarity of a matrix for the first similarity and a matrix for the second similarity.

15. The apparatus of claim 10, wherein the instructions are further configured to cause the one or more processors to update the parameter of the student model so that a loss function based on a matrix for the first similarity and a matrix for the second similarity is minimized.
